(19) United States
(12) Patent Application Publication
(10) Pub. No.: US 2014/0043167 A1
(43) Pub. Date: Feb. 13, 2014

(54) METHOD AND SYSTEM FOR MONITORING A FIREPLACE INSTALLATION

(71) Applicant: BENGT MICHAILOFF, Saltsjo-Boo (SE)

(72) Inventor: BENGT MICHAILOFF, Saltsjo-Boo (SE)

(21) Appl. No.: 14/054,562

(22) Filed: Oct. 15, 2013

Related U.S. Application Data
(63) Continuation of application No. 12/936,012, filed on Oct. 1, 2010, now abandoned.

(30) Foreign Application Priority Data
Apr. 4, 2008 (SE) 0800767-6

(51) Int. Cl. G08B 21/18

(52) U.S. Cl. CPC G08B 21/182
USPC 340/584

(57) ABSTRACT

The present invention relates to a method and a system for monitoring fireplace installation including a built-in/central closed fire-place and/or a steel chimney system. The system includes a first temperature sensor for measuring the surface temperature of the steel chimney system where it passes through the first ceiling strucure, a second temperature sensor for measuring the temperature of heated air return (convection air) to residential rooms, a third temperature sensor for measuring the heat development in flue gas in an area of the steel chimney system, where it is attached to the built-in/central closed fireplace or fireplace insert and a central display unit to inform a user of respective temperature sensors temperature and warn the user if the temperature levels are exceeded.

### TECHNICAL BACKGROUND

The present invention relates to a system and a method for monitoring a fireplace installation comprising a built-in/central closed fireplace or a fireplace insert and/or a steel chimney.

### DESCRIPTION OF PRIOR ART

In recent years it there has been an increase of fire outbreaks in small residential houses. The outbreak of the fire is often related to the fireplace installations comprising a built-in/central closed fireplace or a fireplace insert with an insulated steel chimney system. Examples of such fireplace installations could be the EU types: SS-EN 1856-1: T450-N1-D/W-Vm-L60100-G(50), SS-EN 1856-1: T450-N1-D/W-Vm-L20100-G(50) or SS-EN1856-1/T250-N1-D/W-Vm-L20100-050. Most of these fires happen in small home properties and it is often not exactly known why the fire has started. However, the likelihood that the fire starts due to poor handling of the fireplace by a user is high. Precisely why a fire starts is often hard to prove but the general opinion is the user has used the fireplace in a way that it is not designed or built for. It is generally seen that the user has kept a too strong fire in the fireplace. The development of the heat has in these cases been to high and spread and caused ignition of a fire in surrounding combustible material. It should further be noted that a user of these kinds of fireplaces can still get much heat development in surrounding combustible material, even though he keeps a nominal working temperature in his fireplace.

To overcome the problems mentioned above, some manufacturers supply an analog thermometer intended to be installed within the steel chimney for measuring the flue gas temperature in the chimney. This thermometer needs a hole through the chimney and a bushing in order for the temperature to be visible from the outside. However, this bushing and open hole through the chimney might cause a problem, since there is a risk that flue gas leaks into residential rooms. A further problem with such a thermometer is that it has to be uninstalled when chimney sweeper does his regular cleaning of the chimney. After cleaning the thermometer has to be reinstalled.

US2006/0105280 describes a sensor which can measure a temperature on the outside of a chimney. Preferably the temperature is measured where the chimney is behind a wall or the like in order to control that the temperature close to the wall does not become too high, such that the walls starts burning. The invention is directed towards how the sensor is lead through the wall in order to perform measurements on the outside of a brick chimney.

GB2275099 measures the temperature outside a chimney to control the flow of flue gas through the chimney. The temperature value is used to control the heat flow from the fireplace.

The known methods to measure temperature to prevent fire are relatively simple and do not give full information to the user of the fireplace. There is therefore a need of a method and a system to increase fire security and give users feedback when using fireplaces and or an insulated steel system chimney.

### SUMMARY OF THE INVENTION

The present invention solves the above mentioned problem by monitoring the temperature in three different, from a fire security perspective, critical areas. According to a first aspect of the present invention it relates to a method for monitoring a fireplace including a built-in/central closed fireplace or a fireplace insert and/or a steel chimney including the following steps. Measuring a first temperature on the outside surface of a steel chimney system where it passes through a first ceiling structure, measuring a second temperature, which is the temperature of the hot air return to residential rooms, measuring a third temperature relating to the heat development of the flue gas in an area of the chimney, where the chimney is attached to the to the fire chamber, and transmitting all these temperature values to a display unit, easily accessible to the user of a fireplace installation.

According to a second aspect of the invention it further comprises a method for continuously storing temperature readings in a memory with a specified time interval and use these stored readings to create heat diagrams (statistics etc) for respective temperature measurement and for each occasion the fireplace is used.

According to a third aspect of the invention it comprises a method for warning the user, preferably by a sound generator, whenever any of the measured and monitored areas exceed a predefined set value.

According to a fourth aspect of the invention, it comprises a further method for warning external help if the monitored readings exceed a second predefined set value.

The invention refers to, according to a fifth aspect, a system for monitoring a fireplace installation including a built-in/central closed fireplace or a fireplace insert and/or a steel system chimney comprising a first temperature sensor for measuring a temperature at the surface of the steel chimney where it passes through the first ceiling structure, a second temperature sensor for measuring measure the temperature of the air return (convection air) to the residential rooms, a third temperature sensor for measuring the heat development in flue gas in an area of the chimney, where the chimney is attached to the to the fire chamber and a display unit designed to show a user the temperature of respective temperature sensor.

According to a sixth aspect of the invention it invention relates to a system further including a memory for continuously storing temperature values from the temperature readings with a specified time interval.

According to a seventh aspect of the invention it relates to a system further including a sound generator to warn the user when the temperature from any of the temperature sensors exceeds a predefined set value.

According to an eighth aspect of the invention, it relates to a system further including a automatic calling unit for calling external help or an alarm centre in case the temperature of any of the temperature sensors exceeds a second level predefined set value.

The three measurement areas according to the invention, do affect each other but do not have a direct relative relation to each other. It is not true that the other areas are affected in a direct relative degree to a specific heat development in one area. How much the different areas affect each other is of course complex and unique for each installation of this type of fireplace installation. Factors that do affect are for example size of the built-in/central closed fireplace or the fireplace insert, length of the un-insulated chimney part, the volume of the ventilation through the enclosure containing the fire chamber of the built-in/central closed fireplace or fireplace insert, the size of the ventilation hole, the self induced ventilation or active ventilation, the distance to the first chimney lead-through of ceiling structure, the quality of the installation, the kind of firewood used, the humidity in firewood used, etc.

How much these areas affect each other is also depending on how the user is using his fireplace installation, if the user lets the fire burn down to a good extent between each filling of firewood or if the user adds firewood to the fire earlier. The volume of firewood and how the user controls the air intake to the fire chamber does of course affect as well.

Further, the heat development in one area is not directly related to the heat development in another area. For example, the temperature in the chimney lead-through of the first ceiling structure can continue to rise despite falling flue gas temperatures. Further, the temperature of hot air return to the residential rooms (convection air) can increase if something is blocking ventilation through the enclosure of the built-in/central closed fireplace or fireplace insert.

It is obvious that a user of a fireplace installation must be given control over all these factors in order to be able to use his fireplace in a secure way. It is not enough to only monitor one of the above defined areas but all three must be measured continuously each time a fireplace is used in order to give a good level of fire protection.

The system according to the invention does give the user feedback/information such that the user quickly learns the specifics and properties of his specific fireplace installation and how the heat development is in respective area in order to adjust his usage of the fireplace and avoid ignition of combustible material where it is not intended. Further, by this information the user gets an understanding of his fireplace installation and if it needs any adjustments.

The invention according to the present invention gives the advantage that even very complex environments having fireplace installations can be monitored and give very good fire prevention.

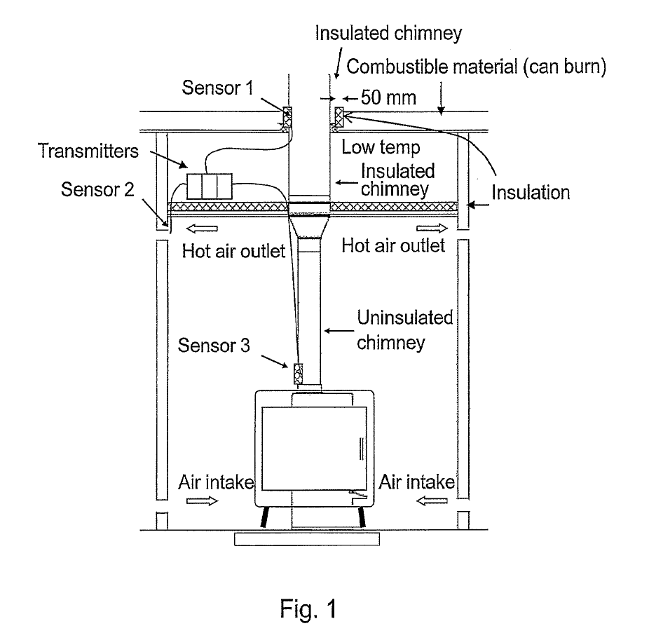

The invention is described more closely below with help of different embodiments and the attached drawing, which in the FIG. 1 shows a fireplace installation.

The problem area is the control over a fireplace installation including a built in/central closed fireplace or fireplace insert and or an installation of an insulated steel chimney system, where users today have little knowledge over how their installation should be used. According to the Swedish Rescue Services Agency there has been an alarming increase of number of fire outbreaks in small residential houses. Users do often use their fireplaces too heavily, in a way that they were not designed for. Naturally only an analogue thermometer is supplied for these kinds of installations. The analogue thermometer does not have any active warning for users and it measures only the flue gas temperature from the fireplace. There are some prevention systems with general measurements and alarm for temperature but no system which address the total problem area as the present invention. Most of these systems concern the measuring of flue gas temperature or temperature within the chimney and not on the outside of the chimney.

The intention with the present invention is to give the user a total control for this type of fireplace installations and thereby save lives, protect property and teach users the specifics/properties of their specific installation by measuring (with high temperature sensors) the following important areas:
1. The outside temperature of an insulated steel chimney system where it passes through the first ceiling structure. The National Swedish Board of Building, Housing and Planning regulates that the maximum allowed temperature is 85° C. for this type of EU approved chimneys. It is relatively easy to use a fireplace in such a way that this temperature exceeds the defined maximum value of 85° C. The user does not normally know that this temperature usually continues to rise as long as there is a fire in the fireplace and even if the fire is coming to an end. When a fire is coming to an end the user normally instead adds more firewood to the fire, which further increases the outside temperature of the chimney in the chimney lead-through of the first ceiling.
2. The hot air return (convection air) to the residential rooms, meaning the air normally taken from residential rooms close to the floor, or from the outside or other ventilated area and then heated by the fire chamber and returned heated to residential rooms. The National Swedish Board of Building, Housing and Planning does not have any maximum temperature values for this area but regulates only that the ventilation holes should have a distance of at least 50 cm from the ceiling. However, there are quite a number of older faulty installations where the ventilation outlets are located too close to the ceiling. In these cases the above maximum value for the chimney passing through the first ceiling structure should be used. The ceiling does normally contain combustible material like wood. In this area it is also relatively easy to override the maximum temperature value, i.e. a temperature of the mixed hot return air at the ceiling over the return air ventilation hole which should be maximum 85° C.
3. The flue gas temperature at the exit from the fire chamber, i.e. where the nominal working temperature for the fireplace is given by the manufacturer of the built in/central closed fireplace or fireplace insert. If this temperature is exceeded there is normally not any hazard of fire outbreaks while the built-in/central fireplace or fireplace insert is normally enclosed in a fireproof surrounding. The problem is instead that the built-in/central closed fireplace or fireplace insert may crack with too high temperatures in the fire chamber with the risk of flue gas leaking into residential rooms. Observe that the flue gas temperature does not have a direct relation to area 1 above. The outside temperature of the chimney in area 1 above does continue to rise even though the temperature in the flue gas falls dramatically by an end of a fire session. Indirectly there is often a fire hazard in area 1 above despite that a fire in the fire chamber has died down to a glow or worse when the user adds more firewood to the fire.

The temperature readings from the three temperature sensors above are transmitted wired or wireless to a central display, showing the temperatures and with an active alarm if the temperature exceed a set value for any of the above areas. For wireless transmission, the 433,92 MHz band may be used (same as weather stations).

At the central display unit the maximum temperatures can be set for all the mentioned areas. The temperature is also showing for all the above areas with an update frequency of 20 seconds (for wireless, continuously for wired). A person skilled in the art understands that other update frequencies may also be used. Exceeding of a temperature gives an alarm by sound and blinking temperature for the affected area.

The temperature for area 1, the chimney lead-through of the first ceiling structure has a second level alarm with 85 decibel in case the temperature continues to rise. The central display unit can also have a wireless interface to home alarm systems with connection to an alarm centre for the second level alarm. The central display unit can also have a WLAN interface for connection to home network and interfacing computer software solution for home surveillance.

The change of temperatures for all of the above areas can easily be followed by the user, who thereby quickly learn how his specific fireplace installation should be used, lowering the air intake to the fire chamber, choose not to add any more firewood, etc. This total knowledge is not given by any other existing system.

An alarm for the area 1 above indicates too heavy usage of the fireplace, flames going up in the chimney, chimney fire, too much firewood in the fire chamber, the fire session being too long, etc. The user can then easily reduce the heat by lowering the air intake to the fire chamber, take a pause in the usage of the fireplace until the chimney has cooled down.

An alarm for the area 2 above indicates too low ventilation through the enclosure of the built-in/central closed fireplace or fireplace insert, blocked ventilation holes, too small ventilation holes. With this knowledge, the user can increase ventilation holes or install active ventilation. For the current occasion make sure that there are enough ventilation in the room until this is addressed.

An alarm in area 3 indicates too strong fire, flames going up in the chimney, too much firewood or too high setting of air intake to fire chamber. Observe that users many times do not know that different types of firewood give different heat levels. The user can easily reduce the heat by lowering the air intake to the fire chamber.

A second level alarm gives an even higher level of protection for those situations where the user does not hear the normal usage warning, have gone to bed, to another room, etc. This alarm signal is designed to wake up people and can be connected to an alarm centre. Of course this alarm setting is normally set on a level before fire outbreak.

There are many types of sensors that might be used in conjunction with the present invention. For example K-thermocouple wire sensors my be are used for measuring temperature, since they can resist very high temperatures.

For the flue gas sensor, preferably a metal sheathed wire sensor is used, which can resist 1200° C. The sensor tip is attached to the outside of the chimney just on top of the fire chamber. This will give a slight delay of flue gas temperature readings, since the steel chimney needs to heat up first. The advantage of this solution is that no hole is required through the chimney. Any hole can cause flue gas leaking into residential rooms. For eliminating heat dissipation from the chimney surface at the location of the sensor tip, mineral wool insulation is attached over the area of connection. This stops flowing air from affecting readings.

For the hot air return (convection), preferably a fiber glass insulated K-thermocouple sensor is used, which can resist 500° C. It is attached so that the tip is located in the hot air return flow.

The same type of sensor, a fiber glass insulated wire sensor which able to resist 500° C., is used for the outside temperature of the chimney for the passing through of the first ceiling. It is attached to the chimney surface within the lead through. Normally this part is not ventilated but insulated also with mineral wool insulation. It should be ensured that the insulation covers the attachment of the sensor. All airflow should be eliminated around the sensor tip for the outside chimney in the lead through of the first ceiling as well as the sensor tip for measuring flue gas temperature, since air flow may affect reading temperatures.

Because of heat dissipation further lead through higher up in a building are not needed to be monitored, since they will have lower temperature than the first.

It should be noted that other countries may have other regulations on temperature levels depending on regulations on the distance to combustible material. The type of material used to a shaft for a chimney and the minimum distance to ceiling of a convection air outlet etc may also vary from country to country. A person skilled in the art readily understands that setting of alarm temperature levels should be according to regulations in each country. Thus, the temperature levels mentioned above should only be seen as examples. The key point of the present invention is to give the user information on temperature levels in all of the three different areas and actively warn the user if any temperature exceeds these limits.

1. A method for monitoring a fireplace installation containing a built-in/central closed fireplace or a fireplace insert and/or a steel chimney system comprising the following steps:
measuring a first outside surface temperature of a steel chimney system, where it passes through a first ceiling structure,
measuring a second temperature of the heated air return (convection air) to residential rooms,
measuring a third temperature of the flue gas at the steel chimney system, where it is attached to the built-in/central closed fireplace or fireplace insert and
transmitting these temperature values to a central display unit which is easily accessible for the user of the fireplace installation.

2. A method according to claim 1, further comprising the step of continuously storing temperature values from the temperature measurements in a memory at defined time interval and collecting values from this memory for creating heat diagrams for each fireplace usage occasion.

3. A method according to claim 1 or 2, further comprising the step of warning the user, preferably with a sound generator, when any of these temperature measurements exceed a predefined value.

4. A method according to claim 3, further comprising the step automatically dialing an external alarm centre if a second predefined temperature level is exceeded.

5. A system for monitoring a fireplace installation comprising a built-in/central closed fireplace or fireplace insert and or a steel chimney system comprising a first temperature sensor for measuring the surface temperature of the steel chimney system, where it passes through the first ceiling structure, a second temperature sensor for measuring the temperature of the heated air return (convection air) to residential rooms, a third temperature sensor for measuring the heat development in flue gas in an area where the steel chimney system is attached to the built-in/central closed fireplace or fireplace insert and a central display unit designed to show a user temperature values from the respective temperature sensors.

6. A system according to claim 5, further comprising a memory for continuously storing values from the temperature measurements at a defined time interval.

7. A system according to claim 5 or 6, further comprising a sound generator and a flashing display to warn the user when any of the temperature sensors exceed a predefined set value.

8. A system according to claim 7, further comprising an automatic dialer for dialing up an external alarm centre if a second predefined temperature level is exceeded.
